(19) United States
(12) Patent Application Publication
(10) Pub. No.: US 2014/0164029 A1
(43) Pub. Date: Jun. 12, 2014

(54) CHECK-IN APPARATUS AND METHOD FOR DETERMINING VISIT TO SHOP IN REAL TIME AND PROVIDING REWARD

(71) Applicant: Electronics and Telecommunications Research Institute, Daejeon-city (KR)

(72) Inventors: Sung-Hoon KWAK, Daegu (KR); Eun-Chang CHOI, Daejeon (KR)

(73) Assignee: Electronics and Telecommunications Research Institute, Daejeon-city (KR)

(21) Appl. No.: 13/918,158

(22) Filed: Jun. 14, 2013

(30) Foreign Application Priority Data
Dec. 7, 2012 (KR) 10-2012-0141617

(51) Int. Cl. G06Q 10/02

(52) U.S. Cl. CPC G06Q 10/02
USPC 705/5

(57) ABSTRACT

Disclosed herein are a check-in apparatus and method. The apparatus includes a sound wave signal reception unit and an information processing unit. The sound wave signal reception unit receives a sound wave signal from a customer's mobile communication device, and restores an ID from the received sound wave signal. The information processing unit extracts customer information and check-in date and time information from the ID restored by the sound wave signal reception unit, generates check-in information by combining the extracted information with shop information and apparatus information stored in the check-in apparatus, and transmits the generated check-in information to a check-in server.

### CROSS REFERENCE TO RELATED APPLICATION

This application claims the benefit of Korean Patent Application No. 10-2012-0141617, filed on Dec. 7, 2012, which is hereby incorporated by reference in its entirety into this application.

### BACKGROUND OF THE INVENTION

1. Technical Field

The present invention relates to technology related to a mobile service that is provided to customers who carry mobile communication devices.

2. Description of the Related Art

Recently, various mobile services or mobile businesses using mobile communication devices (in particular, smart devices) have appeared. For example, in the case of social commerce that sells discount coupons, there is provided a service that determines the current location of a user and then provides information about neighboring shops in which discount coupons are used, using the GPS reception function of a mobile communication device, thereby enabling the user to purchase and use a discount coupon in real time.

In a conventional technology closely related to the present invention, when a customer who carries a mobile communication device visits a shop, such as a department store or a store, the mobile communication device carried by the customer receives a signal from an apparatus that is installed in the shop. The mobile communication device carried by the customer extracts shop information from the received signal, and transmits the extracted shop information and customer's own information to a check-in server, thereby notifying the check-in server that the customer actually visits the shop, that is, of a check-in. The check-in server provides a reward, such as a virtual point, to the customer whose check-in has been determined, according to a preset point provision policy.

Customers like the check-in service because they can enjoy additional benefits using points that are obtained by check-ins. Shop owners utilize the check-in service because they can perform promotion and induce customers to personally visit their shops, thereby increasing their sales.

Korean Patent Application Publication No. 10-2012-0049306 discloses a method and system for detecting a presence, which provide the above-described check-in service.

The check-in technology disclosed in Korean Patent Application Publication No. 10-2012-0049306 has the following two problems.

The first problem is that there is no provision for a means that enables a check-in service provider to easily check whether the apparatus installed in a shop is normally operating. Accordingly, it is not easy to rapidly take measures when a customer cannot perform a check-in or cannot receive a check-in bonus point due to the erroneous operation of the installed apparatus. If the check-in service provider can deal with the failure of the apparatus only when he or she receives a report on the failure from a customer who visits a shop or a shop owner, customers or shop owners become dissatisfied.

The second problem is that the mobile communication device of a customer that has received shop information from the apparatus installed in a shop may use the pay communication function of the mobile communication device of the customer in order to transmit information about a check-in to the check-in server. The mobile communication device carried by the customer has various data communication interfaces based on the type of the mobile communication device, in addition to a voice communication function. When a data communication interface capable of free communication, such as a wireless Local Area Network (LAN), is not installed in a mobile communication device (in the case of, for example, a feature phone), or when a wireless LAN is not deployed in a shop, the mobile communication device should use a pay communication channel when sending information about a check-in to the check-in server. That is, in order to obtain a check-in bonus point, a customer may pay communication fees even though they are small.

According to the statistics of the Korea Communications Commission, at the end of December of 2011, the ratio of smart phone users to mobile communication device users exceeded 40% and was close to 50% in the U.S., West European countries, and Korea. The ratio was less than 10% in China, and the ratio was lower than 20% throughout the world. That is, 80 or more of 100 persons who are currently using mobile communication devices around the world are using mobile communication devices other than smart devices.

In the cases of feature phones, some models have a wireless LAN interface, but most feature phone models have only a wireless data communication function based on a cellular network. Accordingly, when most feature phone users use wireless data communication, they should pay corresponding communication fees. A survey on the use of the wireless Internet that was conducted by the Korea Internet & Security Agency in September of 2009 when smart phones were not introduced to Korea shows the wireless data communication use of Korean feature phone users. According to the results of the survey, 70% or higher of the persons who uses the wireless data communication function of feature phones did not subscribe to flat-rate payment system for the wireless Internet. That is, 70 or more of 100 wireless data users used wireless data communication, and paid fees corresponding to the amount of data used later. Since iPhones were introduced to Korea in November of 2009, persons who used wireless data communication via mobile communication devices have stopped using feature phones and replaced the mobile communication devices with smart phones. Accordingly, it is reasonable to assume that most current feature phone users chiefly use voice communication and a Short Message Service (SMS) function and do not use wireless data communication frequently.

In the situation in which the majority of mobile communication device users still use feature phones, as described above, the check-in technology disclosed in Korean Patent Application Publication No. 10-2012-0049306 may cause service users carrying feature phones to pay additional wireless data fees in order to obtain check-in bonus points.

### SUMMARY OF THE INVENTION

Accordingly, the present invention has been made keeping in mind the above problems occurring in the prior art, and an object of the present invention is to provide a check-in apparatus and method that can determine a visit to a shop in real time without using the pay communication channel of a mobile communication device carried by a customer, and provide a reward for the visit to the shop.

Another object of the present invention is to provide a check-in apparatus and method that enables a check-in service provider to remotely check and determine the status of the check-in apparatus installed in a shop.

In accordance with an aspect of the present invention, there is provided a sound wave transmission method, including generating, by a mobile communication device, an identifier (ID) including customer information; modulating, by the mobile communication device, the generated ID, and transmitting a sound wave signal via a sound wave generator provided in the mobile communication device.

The customer information may include at least one of a customer's name, gender, age, national unique personal number, telephone number, address, nationality, and customer ID and nickname previously stored in a check-in server.

The ID may include at least one of a multiple access protocol redundancy, an error correction code, an error detection code, an encryption code for security, and check-in date and time information.

Transmitting the sound wave signal via the sound wave generator includes transmitting the sound wave signal using any one of a first method of continuously and repeatedly transmitting the sound wave signal, a second method of periodically and repeatedly transmitting the sound wave signal at specific time intervals, a third method of transmitting the sound wave signal only a predetermined number of times, a fourth method of transmitting the sound wave signal only for a predetermined period of time, and a fifth method of transmitting the sound wave signal using a combination of the first to fourth methods until a check-in bonus point is received from a check-in server, thereby reducing power consumption of a battery of the mobile communication device.

In accordance with another aspect of the present invention, there is provided a check-in apparatus, including a sound wave signal reception unit configured to receive a sound wave signal from a customer's mobile communication device, and to restore an ID from the received sound wave signal; and an information processing unit configured to extract customer information and check-in date and time information from the ID restored by the sound wave signal reception unit, to generate check-in information by combining the extracted information with shop information and apparatus information stored in the check-in apparatus, and to transmit the generated check-in information to a check-in server.

The sound wave signal reception unit may have a function of performing signal processing on a multiple access protocol redundancy, an error correction code, an error detection code, and an encryption code for security.

The information processing unit may monitor the status and resource information of the check-in apparatus separately from the generation of the check-in information, and may store the results of the monitoring in a predetermined storage medium and, simultaneously, transmit the results of the monitoring to the check-in server.

The information processing unit may receive a check-in apparatus management message from the check-in server, may perform a management function according to the received check-in apparatus management message, and may transmit the results of the performance to the check-in server.

In accordance with another aspect of the present invention, there is provided a check-in method, including receiving, by a check-in apparatus, a sound wave signal from a customer's mobile communication device, and restoring, by the check-in apparatus, an ID from the received sound wave signal; extracting, by the check-in apparatus, customer information and check-in date and time information from the restored ID; generating, by the check-in apparatus, check-in information by combining the extracted information with shop information and apparatus information stored in the check-in apparatus; and transmitting, by the check-in apparatus, the generated check-in information to a check-in server.

In accordance with still another aspect of the present invention, there is provided a check-in bonus point provision method, including receiving, by a check-in server, check-in information from a check-in apparatus; determining, by the check-in server, validity of a check-in by comparing the received check-in information with customer information, check-in apparatus information, and shop information stored in a database; and, if it is determined that the check-in is valid, providing, by the check-in server, a check-in bonus point to a corresponding customer's mobile communication device a compliance with a check-in bonus point provision policy.

Providing the check-in bonus point to the customer' s mobile communication device may include providing the check-in bonus point using any one of a method of providing the check-in bonus point using a short message service (SMS) message or a free WiFi communication channel, and a method of previously registering a desired pay data communication channel in a database if the customer desires and then providing the check-in bonus point via the registered pay data communication channel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram illustrating a check-in service system for determining a visit to a shop in real time and providing a reward according to an embodiment of the present invention;

FIG. 2 is a drawing illustrating the internal configuration of the mobile communication device illustrated in FIG. 1;

FIG. 3 is a drawing illustrating the internal configuration of the check-in apparatus illustrated in FIG. 1;

FIG. 4 is a drawing illustrating an example of implementing the check-in apparatus illustrated in FIG. 1 using the mobile communication device of a shop owner or a computer installed in a shop; and

FIG. 5 is a flowchart illustrating a method of determining a visit to a shop in real time and providing a reward according to an embodiment of the present invention.

### DESCRIPTION OF THE PREFERRED EMBODIMENTS

Although the present invention is similar to the conventional method in that a check-in bonus point may be provided to a mobile communication device, they are very different from each other in terms of the configurations of a check-in method and system using a mobile communication device and the function and operation of a check-in apparatus installed in a shop. In particular, the mobile communication device of the present invention is distinctive in that it modulates an ID including customer information and transmits the modulated ID to a check-in apparatus over sound waves.

Prior to the detailed description of the present invention, it should be noted that the terms and words used in the specification and the claims should not be construed as being limited to ordinary meanings or dictionary definitions. Further, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

The present invention will be described with reference to the accompanying drawings.

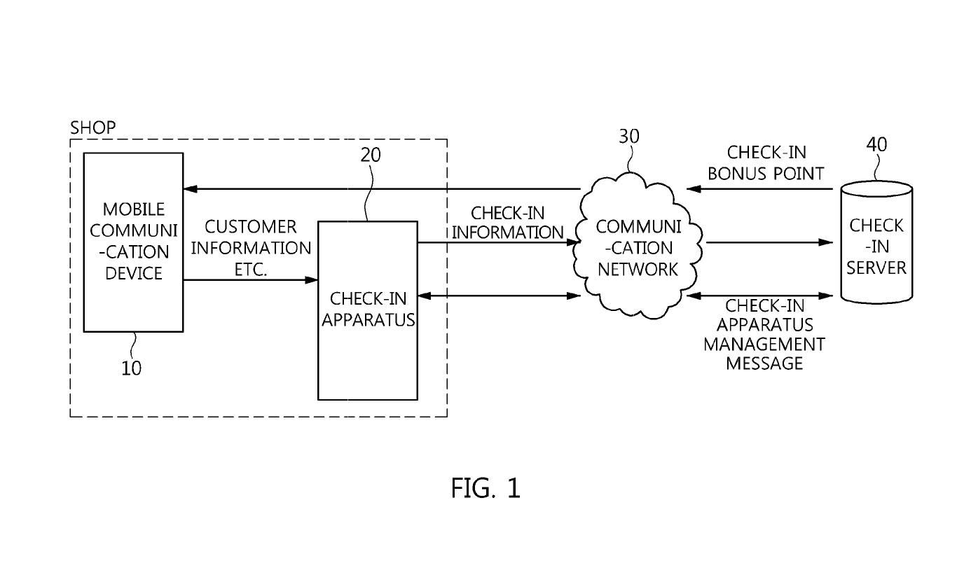

FIG. 1 is a configuration diagram of a check-in service system according to an embodiment of the present invention. The check-in service system according to this embodiment of the present invention includes a mobile communication device 10, a check-in apparatus 20, a communication network 30, and a check-in server 40.

The mobile communication device 10 generates an ID including customer information, and transmits it over sound waves via a speaker (not illustrated).

The check-in apparatus 20 receives the sound wave signal transmitted by the mobile communication device 10. The check-in apparatus 20 restores the ID from the received sound wave signal, and extracts the customer information included in the ID. Furthermore, the check-in apparatus 20 generates check-in information (the customer information, check-in apparatus information, information about a shop in which the check-in apparatus has been installed, etc.) based on the extracted customer information, and transmits it to the check-in server 40.

The communication network 30 allows communication to be smoothly performed between the check-in apparatus 20 and the check-in server 40 and to be smoothly performed between the mobile communication device 10 and the check-in server 40. For example, the communication network 30 includes a wired/wireless Ethernet, a wireless optical communication network, a Bluetooth communication network, a ZigBee communication network, an industrial, scientific, and medical (ISM) band wireless Radio Frequency (RF) communication network, a cellular mobile communication network, a public switched telephone network (PSTN) modem network, a power line communication (PLC) modem network, a broadband Internet modem network, etc.

The check-in server 40 provides a check-in bonus point to the mobile communication device 10 of a customer over the communication network 30. In greater detail, the check-in server 40 receives the check-in information from the check-in apparatus 20 over the communication network 30, and restores the customer information, the check-in apparatus information, and the information about a shop in which the check-in apparatus has been installed from the check-in information. The check-in server 40 determines whether a corresponding check-in is valid by comparing information stored in a database (not illustrated) with the restored information, provides a check-in bonus point to the mobile communication device 10 of the corresponding customer according to a preset check-in bonus point provision policy if the check-in is valid, and notifies the mobile communication device 10 of the corresponding customer of check-in bonus point provision details over the communication network 30. Of the methods of providing, at the check-in server 40, a check-in bonus point to the mobile communication device 10 of the customer, the most preferred methods include a method of providing a check-in bonus point using a short message service (SMS) message or a free WiFi communication channel, and a method of previously registering a desired pay data communication channel in the database if a customer desires and providing a check-in bonus point via the registered pay data communication channel.

The check-in server 40 may periodically exchange check-in apparatus management messages with the check-in apparatuses in order to maintain and manage the check-in apparatuses 20, or may perform one-to-one communication with a check-in apparatus that is specified by a system administrator.

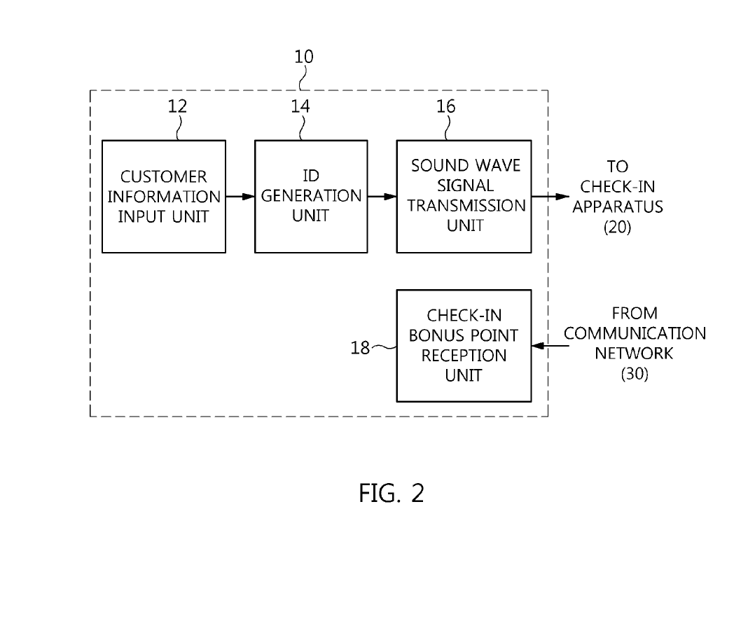

FIG. 2 is a drawing illustrating the internal configuration of the mobile communication device 10 illustrated in FIG. 1.

The mobile communication device 10 includes a customer information input unit 12, an ID generation unit 14, a sound wave signal transmission unit 16, and a check-in bonus point reception unit 18.

The customer information input unit 12 inputs the customer information of a user customer who is using a corresponding mobile communication device 10 to the ID generation unit 14. Here, the customer information includes at least one of the customer's name, gender, age, national unique personal number (for example, a social security number in the U.S.), such as a resident registration number, telephone number, address, nationality, and user ID (customer ID) and nickname previously stored in the check-in server 40. The customer information may be input by the user. Alternatively, the customer information may be previously stored in memory (not illustrated) within the customer information input unit 12, and then the previously stored customer information may be automatically input to the ID generation unit 14.

The ID generation unit 14 generates an ID including the received customer information. Meanwhile, date, day of the week, and time information may be selectively added to the ID depending upon the implementation method used. Furthermore, an error correction code and an error detection code may be selectively added to the ID depending upon the implementation method used. Furthermore, a synchronization preamble and a multiple access protocol redundancy that are required for the multiple access of a TDMA, CDMA, FDMA, or CSMA method may be selectively added to the ID depending upon the implementation method used. Moreover, encryption codes that are required for the security of customer information may be added to the ID depending upon the implementation method used.

The sound wave signal transmission unit 16 modulates the ID generated by the ID generation unit 14, and transmits the modulated ID over sound waves. For example, the sound wave signal transmission unit 16 may be formed of a sound wave generator, such as a speaker, a piezoelectric device, or a buzzer. The sound wave signal transmission unit 16 may be considered to be an example of the sound wave generator that is set forth in the claims of the present application.

In connection with a method for transmitting the sound waves carrying the modulated ID, the sound wave signal transmission unit 16 employs transmission methods that are capable of reducing the power consumption of the battery of the mobile communication device. The first of the methods is to automatically start to transmit a modulated signal (a sound wave signal) carrying an ID at the same time that it is first generated, and continuously repeats the transmission until a transmission termination command is received from a user. The second of the methods is to automatically start to transmit a modulated signal (a sound wave signal) carrying an ID at the same time that it is first generated and to periodically repeat the transmission at specific time intervals. The third of the methods is not to automatically start to transmit a modulated signal (a sound wave signal) carrying an ID at the same time that it is first generated but to start to transmit a modulated signal (a sound wave signal) carrying an ID after a transmission start command has been received from a user. The fourth of the methods is to automatically start to transmit a modulated signal (a sound wave signal) carrying an ID at the same time that it is first generated, to repeat the transmission a preset number of times, and then to automatically stop the transmission. The fifth of the methods is to automatically start to transmit a modulated signal (a sound wave signal) carrying an ID at the same time that it is first generated, to continuously or periodically repeat the transmission for a preset period of time, and then to automatically stop the transmission. The sixth of the methods is to transmit sound waves using a combination of two or more of the first to fifth methods at the same time that the check-in software installed in the mobile communication device 10 is run.

The check-in bonus point reception unit 18 receives a check-in bonus point from the check-in server 40 over the communication network 30.

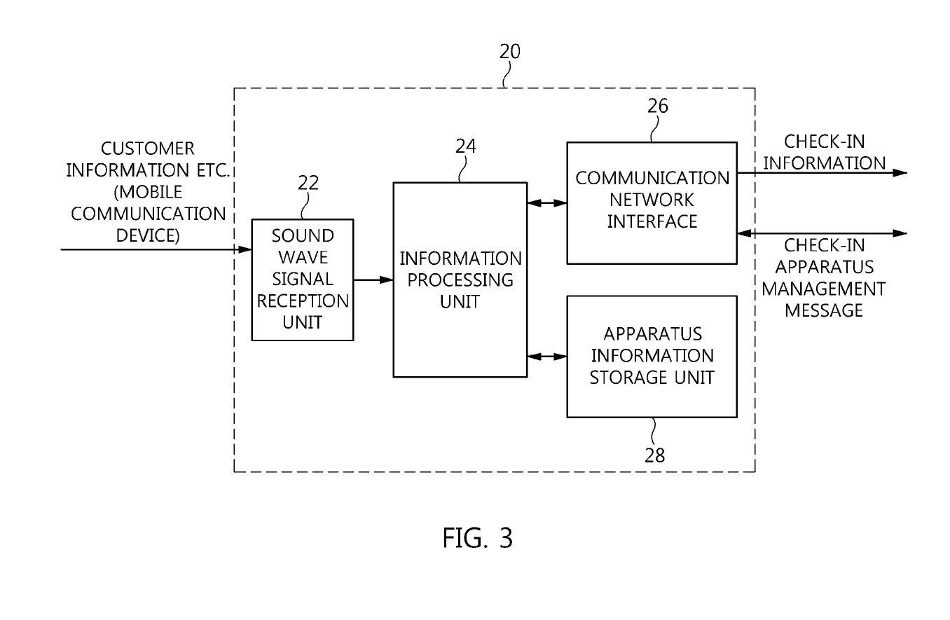

FIG. 3 is a drawing illustrating the internal configuration of the check-in apparatus illustrated in FIG. 1.

The check-in apparatus 20 includes a sound wave signal reception unit 22, an information processing unit 24, a communication network interface 26, and a apparatus information storage unit 28.

The sound wave signal reception unit 22 receives and demodulates a sound wave signal carrying the ID including the customer information transmitted by the mobile communication device 10 of the customer. Depending upon the implementation method used, the sound wave signal reception unit 22 uses the multiple access protocol redundancy of TDMA, CDMA, FDMA, or CSMA, an error correction code or an error detection code, and an encryption code for security in order to restore the ID from the received sound wave signal.

The information processing unit 24 extracts the customer information from the ID restored by the sound wave signal reception unit 22. Furthermore, the information processing unit 24 extracts date, day of the week and time information that are added depending upon the implementation method used from the ID. Meanwhile, the information processing unit 24 extracts at least one of the customer's name, gender, age, national unique personal number (for example, a social security number in the U.S.), such as a resident registration number, telephone number, address, nationality, and user ID (customer ID) and nickname previously stored in the check-in server 40 from the ID.

Thereafter, the information processing unit 24 generates the check-in information including the customer information extracted from the ID, the shop information read from the apparatus information storage unit 28, and the check-in apparatus information, and transmits the generated check-in information to the check-in server 40 via the communication network interface 26.

Preferably, the information processing unit 24 monitors the status information and resource information of the corresponding check-in apparatus 20 related to a processor, a memory, a hard disk, the communication network interface 26, the sound wave signal reception unit 22, a check-in log, and a fault log in order to check the operating status of the check-in apparatus 20. The information processing unit 24 transmits a check-in apparatus management message carrying the results of the monitoring to the check-in server 40, and at the same time stores them in the apparatus information storage unit 28. Meanwhile, the information processing unit 24 receives the check-in apparatus management message from the check-in server 40, performs a management function in accordance with the received check-in apparatus management message, and transmits the results of the performance to the check-in server 40.

The communication network interface 26 is used to perform a connection with the check-in server 40. Various implementation methods, such as a wired/wireless Ethernet interface (for IEEE 802.11 a/b/g/n, Wi-Fi direct), a wireless optical communication interface (for IrDA, visible light optical communication, and LED optical communication), a Bluetooth communication interface, a ZigBee communication interface, an ISM band wireless RF communication interface, a cellular communication interface (for GSM, CDMA, WCDMA, WiBro, WiMax, and LTE), a PSTN modem interface (for DSL, ISDN, and T1/T3), a PLC modem interface, and a broadband Internet modem interface (for optical LAN, FTTx, xDSL, and coaxial cable modems), may be selectively employed.

The apparatus information storage unit 28 stores information including the unique ID of the corresponding check-in apparatus 20, the unique ID of the shop, and operating status information. More preferably, the apparatus information storage unit 28 selectively includes a check-in log, the results of monitoring, a fault log, software version information, and hardware configuration information.

Although the information processing unit 24 and the apparatus information storage unit 28 are illustrated as being separate from each other in FIG. 3, the apparatus information storage unit 28 may be contained in the information processing unit 24, if necessary. If the apparatus information storage unit 28 is contained in the information processing unit 24, the apparatus information may be understood to be stored in the information processing unit 24.

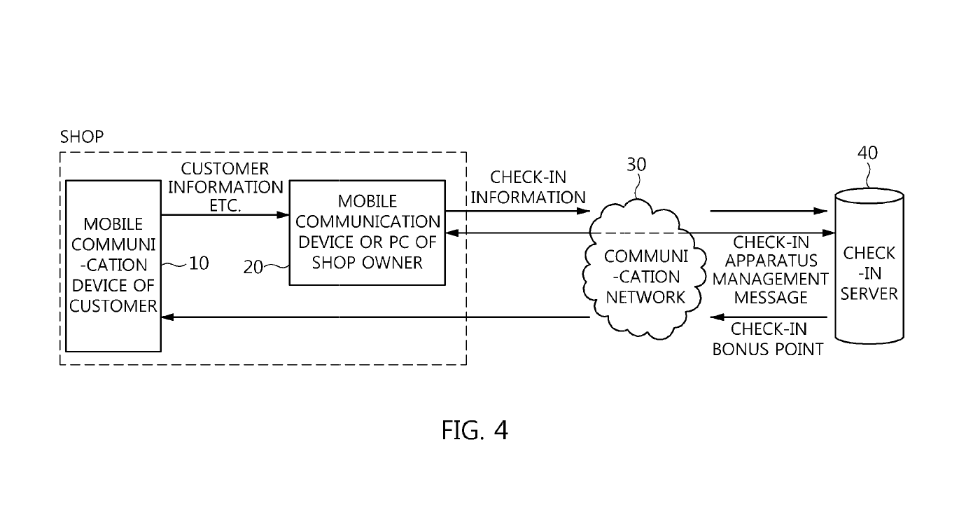

The above-described check-in apparatus 20 in accordance with the method and configuration of the present invention may be fabricated in a separate form, or may be fabricated by implementing the functions in accordance with the method and configuration of the present invention in the mobile communication device of a shop owner or in a computer installed in a shop. FIG. 4 is a drawing illustrating an example of implementing the check-in apparatus illustrated in FIG. 1 using the mobile communication device of a shop owner or a computer installed in a shop.

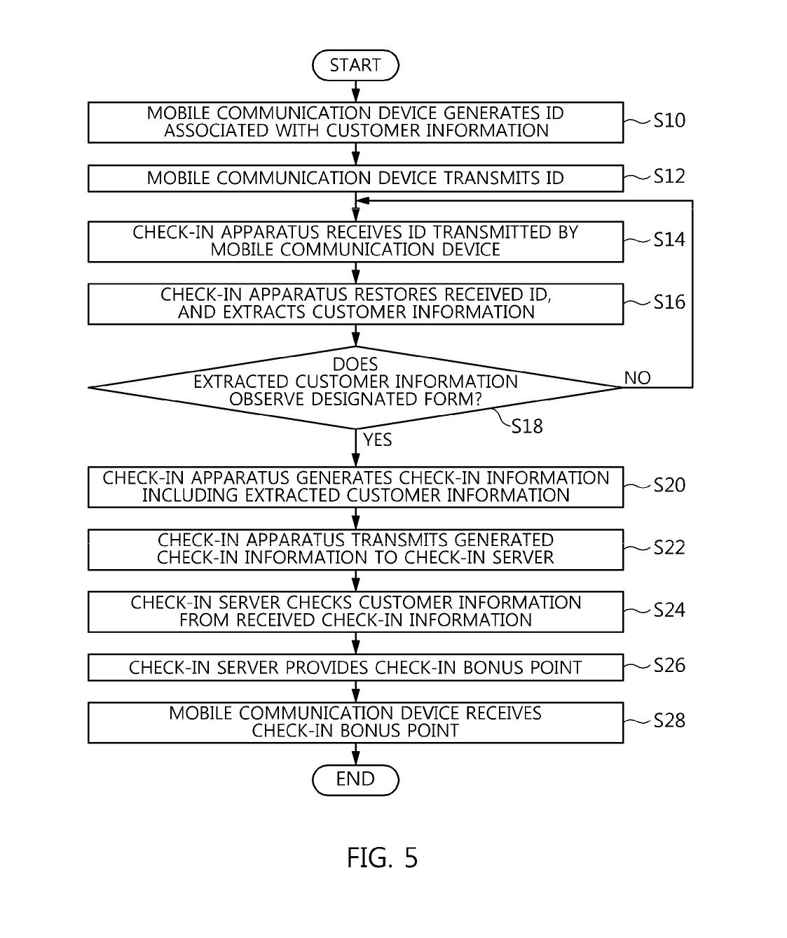

FIG. 5 is a flowchart illustrating a method of determining a visit to a shop in real time and providing a reward according to an embodiment of the present invention.

In accordance with the present invention configured as described above, the check-in apparatus installed in a shop automatically recognize a shopper who visits the shop, and notifies the check-in server of the check-in. Therefore, a shopper can have a check-in detected without using the pay communication channel of a mobile communication device carried by him or her, and thus the present invention achieves the advantage of preventing the shopper from paying communication fees to receive a check-in bonus point.

Furthermore, a check-in service provider can remotely manage the check-in apparatus installed in the shop. Accordingly, the erroneous operation of the check-in apparatus can be easily detected and a failure repair service can be quickly provided, and thus the present invention achieves the advantage of reducing the inconvenience and dissatisfaction of a shop owner and a shopper who visits a shop.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sound wave transmission method, comprising:
generating, by a mobile communication device, an identifier (ID) including customer information;
modulating, by the mobile communication device, the generated ID, and transmitting a sound wave signal via a sound wave generator provided in the mobile communication device.

2. The sound wave transmission method of claim 1, wherein the customer information includes at least one of a customer's name, gender, age, national unique personal number, telephone number, address, nationality, and customer ID and nickname previously stored in a check-in server.

3. The sound wave transmission method of claim 1, wherein the ID includes at least one of a multiple access protocol redundancy, an error correction code, an error detection code, an encryption code for security, and check-in date and time information.

4. The sound wave transmission method of claim 1, wherein transmitting the sound wave signal via the sound wave generator includes transmitting the sound wave signal using any one of a first method of continuously and repeatedly transmitting the sound wave signal, a second method of periodically and repeatedly transmitting the sound wave signal at specific time intervals, a third method of transmitting the sound wave signal only a predetermined number of times, a fourth method of transmitting the sound wave signal only for a predetermined period of time, and a fifth method of transmitting the sound wave signal using a combination of the first to fourth methods until a check-in bonus point is received from a check-in server, thereby reducing power consumption of a battery of the mobile communication device.

5. A check-in apparatus, comprising:
a sound wave signal reception unit configured to receive a sound wave signal from a customer's mobile communication device, and to restore an ID from the received sound wave signal; and
an information processing unit configured to extract customer information and check-in date and time information from the ID restored by the sound wave signal reception unit, to generate check-in information by combining the extracted information with shop information and apparatus information stored in the check-in apparatus, and to transmit the generated check-in information to a check-in server.

6. The check-in apparatus of claim 5, wherein the sound wave signal reception unit has a function of performing signal processing on a multiple access protocol redundancy, an error correction code, an error detection code, and an encryption code for security.

7. The check-in apparatus of claim 5, wherein the information processing unit monitors status information and resource information of the check-in apparatus separately from the generation of the check-in information, and stores results of the monitoring in a predetermined storage medium and, simultaneously, transmits the results of the monitoring to the check-in server.

8. The check-in apparatus of claim 5, wherein the information processing unit receives a check-in apparatus management message from the check-in server, performs a management function according to the received check-in apparatus management message, and transmits results of the performance to the check-in server.

9. A check-in method, comprising:
receiving, by a check-in apparatus, a sound wave signal from a customer's mobile communication device, and restoring, by the check-in apparatus, an ID from the received sound wave signal;
extracting, by the check-in apparatus, customer information and check-in date and time information from the restored ID;
generating, by the check-in apparatus, check-in information by combining the extracted information with shop information and apparatus information stored in the check-in apparatus; and
transmitting, by the check-in apparatus, the generated check-in information to a check-in server.

10. A check-in bonus point provision method, comprising:
receiving, by a check-in server, check-in information from a check-in apparatus;
determining, by the check-in server, validity of a check-in by comparing the received check-in information with customer information, check-in apparatus information, and shop information stored in a database; and
if it is determined that the check-in is valid, providing, by the check-in server, a check-in bonus point to a corresponding customer's mobile communication device a compliance with a check-in bonus point provision policy.

11. The check-in bonus point provision method of claim 10, wherein providing the check-in bonus point to the customer's mobile communication device includes providing the check-in bonus point using any one of a method of providing the check-in bonus point using a short message service (SMS) message or a free WiFi communication channel, and a method of previously registering a desired pay data communication channel in a database if the customer desires and then providing the check-in bonus point via the registered pay data communication channel.
